(19) United States
(12) Patent Application Publication
(10) Pub. No.: US 2010/0230927 A1
(43) Pub. Date: Sep. 16, 2010

(54) FOLDING BICYCLE

(76) Inventor: Chun-Chuan Huang, Changhua County (TW)

Correspondence Address: WPAT, PC;INTELLECTUAL PROPERTY ATTORNEYS, 2030 MAIN STREET, SUITE 1300, IRVINE, CA, 92614, US

(21) Appl. No.: 12/703,330

(22) Filed: Feb. 10, 2010

(30) Foreign Application Priority Data
Mar. 11, 2009 (TW) 098203685

(51) Int. Cl. B62K 15/00

(52) U.S. Cl. 280/278

(57) ABSTRACT

A folding bicycle includes a frame, a steering unit, a shaft tube coupled to a first end of the frame and to the steering unit, a front fork linked with the steering unit through the shaft tube, a front wheel mounted onto the front fork, a rear fork coupled to a second end of the frame, a rear wheel mounted onto the rear fork, and a seat unit installed onto the frame. A folding unit is installed at a central position of the frame, and the first and second ends of the frame include a first pivot and a second pivot respectively, such that if the frame is folded by means of the folding unit, the first and second pivots are stacked with each other to achieve the effect of reducing the folding volume of the bicycle.

### CROSS-REFERENCE TO RELATED APPLICATIONS

This non-provisional application claims priority under 35 U.S.C. §119(a) on Patent Application No(s).098203685 filed in Taiwan, R.O.C. on 11 Mar. 2009, the entire contents of which are hereby incorporated by reference.

### FIELD OF THE INVENTION

The present invention relates to a bicycle, in particular to a folding bicycle capable of reducing a folding volume of the bicycle.

### BACKGROUND OF THE INVENTION

In general, folding bicycles become increasingly popular in the consumer market, since the folding bicycles occupy not much space and provide an easy storage and an easy transportation such as carrying the bicycles in a car trunk. There are various different types of folding structures, and the folding bicycles at an early stage come with a folding box structure mounted onto a top tube of a bicycle frame or between top and down tubes of the bicycle, such that the frame can be folded pivotally by the folding box. However, the folding box pivotally turned sideway for folding the bicycle will affect the overall aesthetic look of the bicycle. Furthermore, after a general folding bicycle is folded, the frame is usually not folded symmetrically, and thus the front and rear wheels cannot be stacked precisely, and the transversal length of the folded bicycle is still too long, and the folded frame is protruded from the stacked front and rear wheels. As the result, the overall folding volume of the bicycle cannot be reduced effectively.

In view of the aforementioned shortcomings of the prior art, the inventor of the present invention based on years of experience in the related industry to conduct extensive researches and experiments, and finally developed a folding bicycle with a simple design to achieve the effect of reducing the folding volume of the bicycle.

### SUMMARY OF THE INVENTION

Therefore, it is a primary objective of the present invention to design a folding bicycle to achieve the effect of reducing the folding volume of the bicycle.

To achieve the foregoing objectives, the present invention provides a folding bicycle comprising a frame, a steering unit, a shaft tube coupled to a first end of the frame and to the steering unit, a front fork linked with the steering unit through the shaft tube, a front wheel mounted onto the front fork, a rear fork coupled to a second end of the frame, a rear wheel mounted onto the rear fork, and a seat unit installed onto the frame, wherein a folding unit is installed at a central position of the frame, and the first and second ends of the frame include a first pivot and a second pivot respectively, such that if the frame is folded by means of the folding unit, the first and second pivots are stacked with each other to achieve the effect of reducing the folding volume of the bicycle.

To make it easier for the examiner to understand the objects, characteristics and effects of this invention, we use preferred embodiments together with the attached drawings for the detailed description of the invention as follows.

### BRIEF DESCRIPTION OF THE DRAWINGS

FIG. 1 is a perspective view of a folding bicycle in accordance with the present invention;

FIG. 2 is a schematic view of folding a folding bicycle in accordance with the present invention;

FIG. 3 is a schematic view of folding a folding bicycle in accordance with the present invention;

FIG. 4 is a schematic view of folding a folding bicycle in accordance with the present invention; and

FIG. 5 is a schematic view of folding a folding bicycle in accordance with the present invention.

### DESCRIPTION OF THE PREFERRED EMBODIMENTS

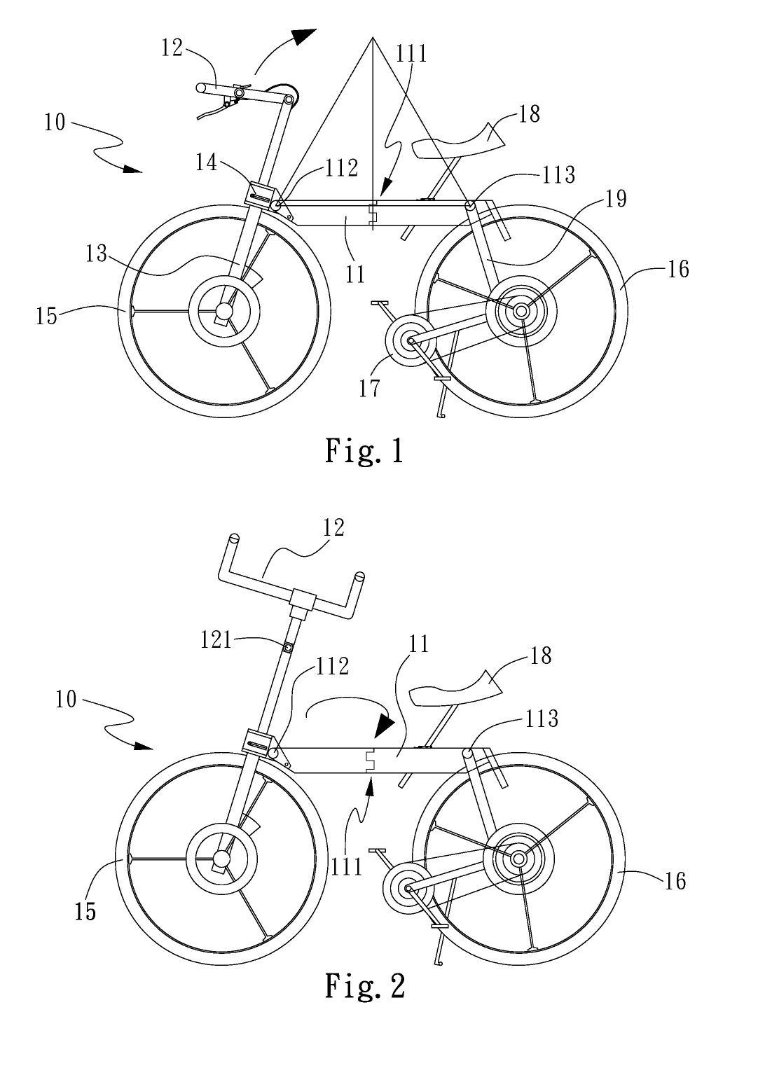

With reference to FIG. 1 for a perspective view of a folding bicycle in accordance with the present invention, the folding bicycle 10 comprises a frame 11, a steering unit 12, a shaft tube 14 coupled to a first end of the frame 11 and to the steering unit 12, a front fork 13 linked to the steering unit 12 through the shaft tube 14, a front wheel 15 mounted onto the front fork 13, a rear fork 19 coupled to a second end of the frame 11, a rear wheel 16 mounted onto the rear fork 19, and a seat unit 18 installed onto the frame 11. A folding unit 111 is installed at a central position of the frame 11, and the first and second ends of the frame 11 include a first pivot 112 and a second pivot 113 respectively.

A user can sit on the seat unit 18 to ride the folding bicycle 10 and control the turning direction of the linked front fork 13 through the steering unit 12 in order to control the front wheel 15 and the traveling direction of the folding bicycle 10. The rear wheel 16 is connected to a pedal unit 17, and the pedal unit 17 provides a dynamic force for driving the folding bicycle 10.

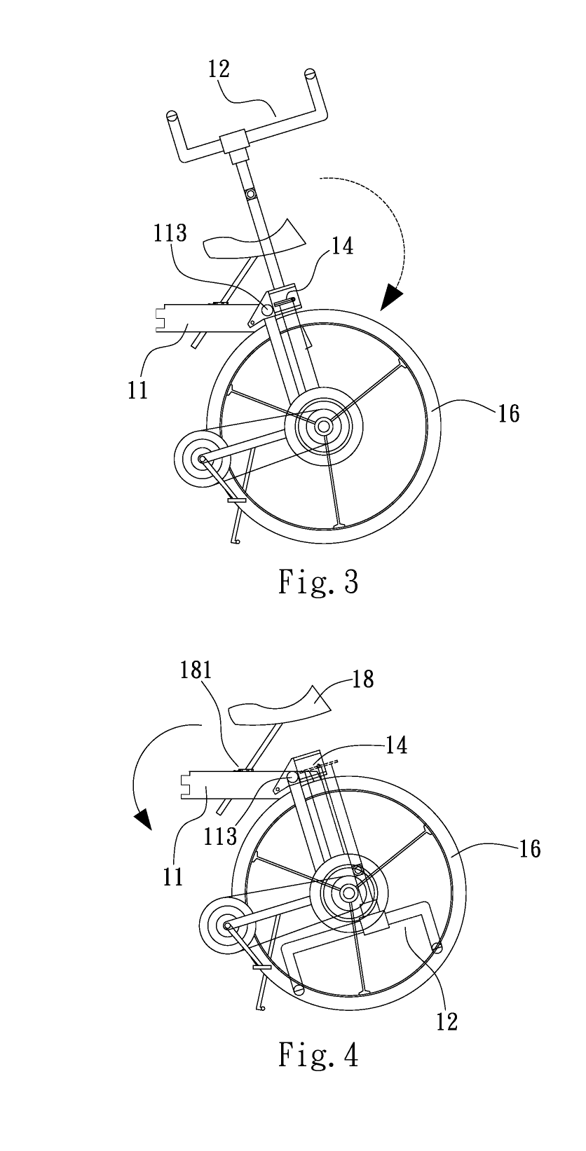

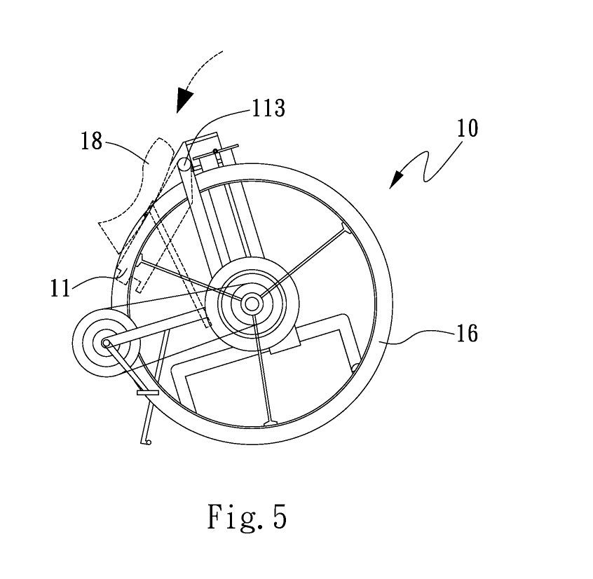

With reference to FIGS. 2 to 5 for schematic views of folding a folding bicycle in accordance with the present invention, if a user wants to fold the folding bicycle 10, the user can adjust the steering unit 12 into a plane coplanar with the front wheel 15 and the rear wheel 16 by using a quick-release axle 121 installed on the steering unit 12, and then the folding unit 111 is used for folding the folding bicycle 10. The folding unit 111 can be a quick-release folding unit, such that the user can loosen the folding unit 111 quickly. Since the folding unit 111 is installed at the central position of the frame 11, therefore the first pivot 112 and the second pivot 113 installed at the first and second ends of the frame 11 respectively are stacked with each other, and the front wheel 15 and the rear wheel 16 are stacked with each other to reduce the folding volume of the folding bicycle 10. In addition, the shaft tube 14 can be a quick-release folding shaft tube, so that the user can fold the front wheel 15 and the rear wheel 16 into a plane coplanar to the steering unit 12 quickly to abut the top of the front wheel 15 or the rear wheel 16 by the quick-release folding shaft tube, so as to further reduce the folding volume of the folding bicycle 10.

After the frame 11 is folded, the first pivot 112 and the second pivot 113 installed at the first and second ends of the frame 11 respectively can be stacked with each other, such that the first pivot 112 and the second pivot 113 can be rotated to turn the frame 11 other than the stacked front wheel 15 and rear wheel 16 inwardly, until falling into a space between the stacked front wheel 15 and rear wheel 16. Such arrangement further reduces the folding volume of the folding bicycle 10 effectively. In addition, the seat unit 18 is fixed to the frame 12 by a quick-release fixing unit 181, such that the quick-release fixing unit 181 can be loosened quickly for folding the folding bicycle 10, and the seat unit 18 can be adjusted to a position proximate to the frame 11 or removed directly to reduce the folding volume of the folding bicycle 10.

If the folding bicycle 10 is unfolded into its original form, it is necessary to maintain the overall fixity and stability of the folding bicycle 10, and thus each of the first pivot 112 and the second pivot 113 includes a quick-release position limiting unit (not shown in the figure) for restricting the rotation of the first pivot 112 and the second pivot 113 to maintain the fixity and stability of the folding bicycle 10.

In summation of the description above, the design of the folding bicycle in accordance with the present invention is feasible, and the products of the invention can meet the market requirements, and the present invention complies with patent application requirements, and thus is duly filed for patent application.

While the invention has been described by means of specific embodiments, numerous modifications and variations could be made thereto by those skilled in the art without departing from the scope and spirit of the invention set forth in the claims.

What is claimed is:

1. A folding bicycle, comprising a frame, a steering unit, a shaft tube coupled to a first end of the frame and to the steering unit, a front fork linked with the steering unit through the shaft tube, a front wheel mounted onto the front fork, a rear fork coupled to a second end of the frame, a rear wheel mounted onto the rear fork, and a seat unit installed onto the frame, characterized in that a folding unit is installed at a central position of the frame, and the first and second ends of the frame include a first pivot and a second pivot respectively, such that if the frame is folded by means of the folding unit, the first and second pivots are stacked with each other.

2. The folding bicycle of claim 1, wherein the shaft tube is a quick-release folding shaft tube.

3. The folding bicycle of claim 1, wherein the folding unit is a quick-release folding unit.

4. The folding bicycle of claim 1, wherein the rear wheel is coupled to a pedal unit for providing a dynamic force for driving the folding bicycle.

5. The folding bicycle of claim 1, wherein the steering unit includes a quick-release axle installed thereon.

6. The folding bicycle of claim 1, wherein the seat unit is fixed integrally with the frame by using a quick-release fixing unit.

7. The folding bicycle of claim 1, further comprising a quick-release position limiting unit for limiting a rotation of the first pivot.

8. The folding bicycle of claim 1, further comprising a quick-release position limiting unit for limiting a rotation of the second pivot.
